(19) United States
(12) Patent Application Publication
(10) Pub. No.: US 2026/0153130 A1
(43) Pub. Date: Jun. 4, 2026

(54) INNER JOINT MEMBER FOR A COUNTER TRACK JOINT

(71) Applicant: GKN Driveline Zumaia SA, Zumaia (ES)

(72) Inventors: Jesús Abenójar, Zumaia (ES); Iñaki Gutiérrez, Zumaia (ES); Unai Querejeta, Zumaia (ES); Jon Iruretagoyena, Zumaia (ES)

(21) Appl. No.: 19/404,468

(22) Filed: Dec. 1, 2025

(30) Foreign Application Priority Data
Dec. 2, 2024 (DE) 102024135686.3

(51) Int. Cl. F16D 3/223

(52) U.S. Cl. CPC F16D 3/223; F16D 2003/22303

(57) ABSTRACT

An inner joint member for a counter track joint, comprising a through-opening having an engaging structure for inserting a drive shaft from the front side and having an axial securing structure toward the rear side; first ball tracks inclined toward the front side; second ball tracks which are inclined towards the rear side, wherein the inner joint member has recesses on the front side at least in circumferential sections with the second ball tracks which are recessed relative to the track base, wherein the radial thickness formed between the recess and the through-opening is less than 1.3 times the smallest radial thickness formed on the front side between the first ball tracks and the through-opening. A counter track joint is described with such an inner joint member.

### CROSS REFERENCE TO RELATED APPLICATIONS

This application claims priority to German Patent Application No. DE102024135686.3 filed on Dec. 2, 2024, and the content of this priority application is incorporated herein by reference in its entirety.

### TECHNICAL FIELD

The present disclosure relates to an inner joint member for a constant velocity joint in the form of a counter track joint.

### BACKGROUND

Counter-track joints have an even number of track pairs. A first number of the track pairs open in the direction of a first end of the outer joint part and the other number of track pairs open in the direction of the second end of the outer joint part. The first and second pairs of tracks are arranged alternately in the circumferential direction. The number of pairs of tracks is even, e.g. 6, 8 or 10.

A counter-track joint is known, for example, from WO 2013/029655 A1. When the joint is in an aligned position, first pairs of tracks open in the direction of the opening side, and second pairs of tracks open in the direction of the connection side. The control angle of the first pair of tracks is greater than the control angle of the second pair of tracks. The inner joint part has a continuous opening with a conical insertion face into which a drive shaft is inserted.

WO 2022/122170 A1 discloses another counter track joint. The first and second ball tracks of the outer joint part are soft finished and hardened. The first and second ball tracks of the inner joint part are preformed, hardened and hard-finished after hardening.

JP2008095804A discloses a constant velocity joint comprising an outer ring having a plurality of guide grooves in a concave spherical inner face, and an inner ring having a plurality of guide grooves in a convex spherical outer face. The pairs of guide grooves all have the same shape so that they open in the same axial direction. A torque-transmitting ball is provided in each pair of grooves. The balls are housed in pockets of a ball cage located between the spherical inner face of the outer ring and the spherical outer face of the inner ring.

Another constant velocity joint is known from JP2008267478A, in which the pairs of ball tracks have the same shape so that they open in the same axial direction. To facilitate mounting of the inner ring into the ball cage, one end of the outer spherical face of the inner ring is cut out to form an inclined or stepped face. In this way, the convex part of the inner ring can be inserted into the cage window without obstruction by the web cut adjacent to the window.

Another constant velocity joint is known from JP2008249070A, in which the pairs of tracks all have the same shape. The inner ring includes a bevelled portion in one or all of the ball tracks to facilitate mounting of the inner ring in the ball cage. The bevelled portion is provided at the end edge area of the ball track.

An object of at least some implementations of the present disclosure is to propose an inner joint member for a counter track joint which has a long service life. The object is further to propose a counter track joint with such an inner joint member having a long service life.

### SUMMARY

To solve the object, an inner joint member for a counter track joint is proposed, comprising a through-opening with a longitudinal axis and an engagement structure into which a drive shaft is axially insertable from a front side for transmitting torque, wherein an axial securing structure for axial securing of the drive shaft is provided in the through-opening between a center plane and a rear side; first ball tracks which, viewed in the center plane, are inclined towards the front side, wherein the inner joint member has a smallest radial thickness on the front side radially between the first ball tracks and the through-opening; second ball tracks which, viewed in the center plane, are inclined towards the rear side, wherein the inner joint member has a smallest radial thickness on the rear side radially between the second ball tracks and the through-opening; wherein the inner joint member has recesses at least in circumferential portions overlapping with the second ball tracks, which recesses, viewed in longitudinal section through the track base, are recessed relative to a continued imaginary track base line and extend axially to the front side, wherein a radial thickness formed at the front side between a recess and the through-opening is less than 1.3 times the smallest radial thickness between the first ball tracks and the through-opening at the front side.

An advantage of the inner joint member for a counter track joint is that the recesses on the ball tracks opening towards the first side cause a reduction in stiffness in these circumferential areas of the inner joint member. This leads to an improved stress distribution in the inner joint member, in particular also at the engagement structure for a rotationally fixed connection to the drive shaft. This can reduce the torsional fatigue of the inner joint member and extend its service life. In a further advantageous configuration, the inner joint member can also be provided with a smaller number of engagement elements, for example splines for torque transmission, due to the improved stress distribution. This may allow the diameter of the shaft to be reduced, which in turn has a favorable effect on the size and weight.

The circumferentially distributed web sections of the inner joint member can form a curved, in particular spherical outer face. The center plane of the inner joint member can be defined by points on the curved outer face, which are furthest from the longitudinal axis. The axial securing structure for axially securing the drive shaft to the inner joint member is provided in a rear portion of the through-opening, i.e. somewhere between the center plane and the rear end face.

The first ball tracks may each have a central section for guiding an associated ball during operation, a front section extending toward the front end face and a rear section extending toward the rear section. The front and rear sections have no guiding function when the joint is in operation, i.e. at articulation angles outside an operating articulation angle. The inner joint member has a smallest radial thickness in the area of the front track sections on the front end face, i.e., an annular portion of the inner joint member surrounding the through-opening is relatively thin in the circumferential areas of the first ball tracks. In order to improve the stress distribution, the recessed portions at the second ball tracks can be designed such that the annular portion surrounding the through-opening in the circumferential areas of the recesses of the second ball tracks on the front end face is similarly thick as in the circumferential areas of the first ball tracks. In particular, it can be provided that the smallest radial thickness of the inner joint member in the recessed portions at the second ball tracks at the front end is less than 1.1 times the smallest radial thickness of the inner joint member in the circumferential sections of the first ball tracks.

Alternatively, or additionally, with regard to the second ball tracks, the radial thickness formed on the front side between the recess and the through-opening may also be less than 1.3 times, in particular less than 1.1 times, the smallest radial thickness between the second ball tracks and the through-opening on the rear front side.

According to a first embodiment, a plurality of recesses distributed around the circumference are provided, namely a recess on/at every second ball track which extends to the front end face. The recesses can each extend in the circumferential direction over at least ±10° in relation to a radial plane defined or spanned by a base line of the respectively associated second ball track. Alternatively or additionally, the circumferential extent of a recess can be smaller than an angular pitch between two web sections adjacent to each other in the circumferential direction, respectively between two ball tracks adjacent to each other in the circumferential direction. The angular pitch between two webs and/or ball tracks depends on their number. A joint with six ball tracks and webs, respectively, has an angular pitch of 60° when evenly circumferentially distributed; a joint with eight ball tracks and webs, respectively, has an angular pitch of 45° when evenly distributed. The web sections adjacent to the recesses in the circumferential direction can merge continuously into the front end face.

The circumferentially distributed recesses, which can also be referred to as indentations, can extend from the front end face over an axial length of at least 0.1 times the axial length of the inner joint member. More specifically, the recesses can also extend over a length of more than 0.2 times or 0.3 times, or even more than 0.5 times, the axial length of the inner joint member. Viewed in longitudinal section, the recesses, respectively indentations can have a rounded, in particular concave, or a straight shape.

According to a second embodiment, the recesses are formed by an annular groove arranged in the front end face coaxially to the longitudinal axis, the annular groove being arranged radially between an inner edge and an outer edge of the front end face. In this embodiment, a single recess is thus provided, which is annular and intersects the front sections of all first and second ball tracks in the circumferential direction. The annular groove can simply be worked into the front face of the inner joint member by a turning or forming process. Viewed in semi-longitudinal section, the annular groove can have a radial extent of at least 0.3 times the radial extent from the inner edge to the outer edge of the first axial end face. In cross-section through the annular groove, respectively longitudinal section through the joint, the annular groove preferably has a rounded shape. In particular, the axial depth of the annular groove can be at least and/or more than 0.1 times the axial length of the inner joint member.

The above-mentioned object is further solved by a constant velocity joint in the form of a counter track joint, comprising: an inner joint member, which is designed according to one of the above-mentioned embodiments, and an outer joint member with a longitudinal axis, a connecting side and an opening side as well as first ball tracks and second ball tracks; wherein the first ball tracks of the outer joint member and the first ball tracks of the inner joint member together form first pairs of ball tracks which, in the aligned state of the counter track joint, widen towards the opening side of the outer joint member, and wherein the second ball tracks of the outer joint member and the second ball tracks of the inner joint member together form second pairs of ball tracks which, in the aligned state of the counter track joint, widen towards the connection side of the outer joint member; a torque-transmitting ball in each first pair of ball tracks and in each second pair of ball tracks; an annular ball cage arranged between the outer joint member and the inner joint member and having cage windows distributed in the circumferential direction, in each of which at least one of the torque-transmitting balls is received.

A counter track joint with an inner joint member has an advantageously long service life. The counter track joint can, for example, be designed for relatively small operating articulation angles of less than 25°. The inner and outer joint members may also be referred to as inner and outer joint parts.

### BRIEF DESCRIPTION OF THE DRAWINGS

Certain embodiments are explained below with reference to the drawing figures. Herein:

FIG. 1A shows a perspective view of an inner joint member in a first embodiment;

FIG. 1B shows another perspective view of the inner joint member from FIG. 1A;

FIG. 1C shows the inner joint member from FIG. 1A in side or radial view;

FIG. 1D shows the inner joint member from FIG. 1A in longitudinal section through the base of a first ball track (upper half of the section) and a second ball track (lower half of the section);

FIG. 2A shows an axial view of a counter track joint with an inner joint member as shown in FIGS. 1A to 1D;

FIG. 2B shows the counter track joint according to section line 2B-2B from FIG. 2A;

FIG. 3A shows a perspective view of an inner joint member in a second embodiment;

FIG. 3B shows another perspective view of the inner joint member from FIG. 3A;

FIG. 3C shows the inner joint member shown in FIG. 3A in side or radial view;

FIG. 3D shows the inner joint member shown in FIG. 3A in longitudinal section through the base of a first ball track (upper half of the section) and a second ball track (lower half of the section);

FIG. 4A shows an axial view of a counter track joint with an inner joint member as shown in FIGS. 3A to 3D;

FIG. 4B shows the counter track joint according to section line 4B-4B from FIG. 4A;

FIG. 5A shows a perspective view of an inner joint member in a third embodiment;

FIG. 5B shows another perspective view of the inner joint member from FIG. 5A;

FIG. 5C shows the inner joint member from FIG. 5A in a longitudinal section through two web sections;

FIG. 5D shows the inner joint member from FIG. 5A in longitudinal section through the base of a first ball track (upper half of the section) and a second ball track (lower half of the section);

FIG. 6A shows an axial view of a counter track joint with an inner joint member as shown in FIGS. 5A to 5D;

FIG. 6B shows the counter track joint according to section line 6B-6B from FIG. 6A;

FIG. 7A shows an inner joint member in a further embodiment in longitudinal section through two web sections; and

FIG. 7B shows the joint inner member from FIG. 7A in longitudinal section through the track base of a first ball track (upper half of the section) and a second ball track (lower half of the section).

### DETAILED DESCRIPTION

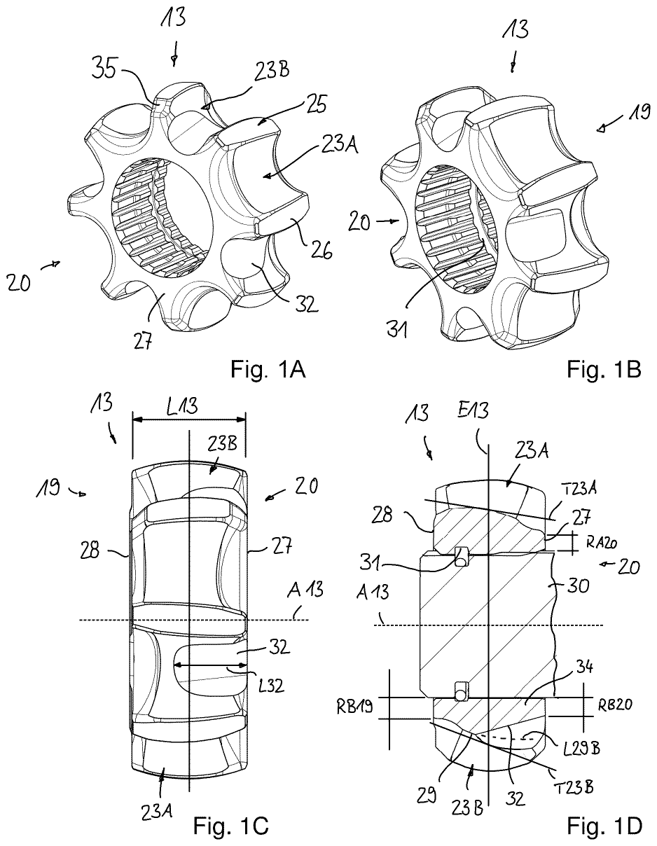

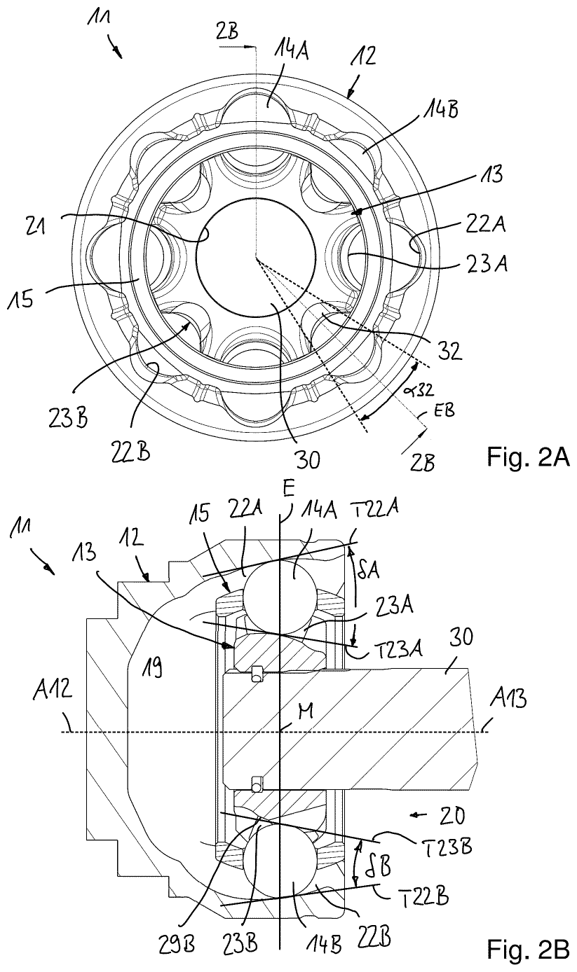

FIGS. 1A to 1D, together also referred to as FIG. 1 for short, show an inner joint member 13 for a counter track joint. A counter track joint 11 with such an inner joint member 13 is shown in FIGS. 2A and 2B, which together are also referred to as FIG. 2 for short.

The counter track joint 11 comprises an outer joint member 12, an inner joint member 13, a plurality of torque-transmitting balls 14A, 14B and a ball cage 15, which is arranged between the inner face 24 of the outer joint member 12 and the outer face 26 of the inner joint member 13. The balls 14A, 14B are received in circumferentially distributed cage windows 18 in the ball cage 15 and, in an aligned state of the constant velocity joint, they define a joint center plane EM. The outer joint member 12 has a longitudinal axis A12, and the inner joint member 13 has a longitudinal axis A13. The intersection of the longitudinal axes A12, A13 with the joint center plane EM forms the joint center point M. The counter track joint 11 is designed in particular so that the outer joint member 12 and the inner joint member 13 are angularly movable relative to each other by an articulation angle β of up to a maximum of 30°. It is understood, however, that designs with larger articulation angles are also possible.

The inner joint member 13 is ring-shaped and has a plurality of circumferentially distributed first and second ball tracks 23A, 23B, between which a web section 25 is respectively formed in the circumferential direction. The web sections 25 form an outer face 26 of the inner joint member 13. The location of the side of the inner joint member 13 into which the shaft is inserted is also referred to as the front side 20 or opening side. The location of the opposite side of the inner joint member 13 is also referred to as the rear side 19 or bottom side. The inner joint member 13 also has a first end face, which is also referred to as the front end face 27, and an opposite second end face, which is also referred to as the rear end face 28.

The through-opening 21, into which the journal of a drive shaft 30 is insertable in a rotationally fixed manner to transmit a torque, defines the longitudinal axis A13 of the inner joint member 13. The through-opening 21 has an engagement structure to transmit torque about the longitudinal axis A13 to the drive shaft 30. For this purpose, the drive shaft 30 has an opposing engagement structure. The engagement structure can, for example, be designed in the form of splines or the like. The through-opening 21 also has an axial securing structure 31 in the rear section of the inner joint member to axially secure or connect the inserted drive shaft 30. The axial securing structure 31 can, for example, be designed in the form of an annular groove into which an axial securing ring, respectively retaining ring is insertable, without being limited thereto.

With the outer joint member 12 and inner joint member 13 aligned coaxially, the tangents T22A, T23A to the balls 14A form an opening angle δA at the contact points with the first tracks 22A, 23A, which opens towards the front side 20, respectively opening side. The second balls 14B are guided in outer ball tracks 22B in the outer joint member 12 and inner ball tracks 23B in the inner joint member 13. The balls 14A of the first ball tracks 22A, 23A are shown with contact in the track base of the ball tracks, without being limited thereto. Thus, in the present embodiment, the balls 14B of the second ball tracks 22B, 23B have a small gap to the track base 29B of the inner ball tracks 23B. In the aligned position shown in FIG. 2, the tangents T22B, T23B to the second balls 14B form a second opening angle δB at the contact points with the second tracks 22B, 23B, which opens towards the rear side 19 or bottom side, respectively.

Further details of the inner joint member 13 according to the embodiment shown in FIG. 1 are described in more detail below. The outer face 26 formed by the circumferentially distributed web sections 25 is in particular spherical, without being limited thereto. Points on the outer face 26 which are furthest from the longitudinal axis A13, define a center plane E13 of the inner joint member 13. The through-opening 21 has an annular groove 31 for a retaining ring, which is arranged in a rear region of the inner joint member, i.e. axially between the center plane E13 and the rear end face 28. As shown by the tangents T23A, T23B marked on the ball tracks in the center plane in FIG. 1D, the first ball tracks 23A are inclined towards the front side 20, whereas the second ball tracks 23B are inclined towards the rear side.

In circumferential sections of the second ball tracks 23B, the inner joint member 13 has a radial thickness RB19 at the rear end face 28. At the front end face 27, the inner joint member 13 has recessed portions 32 in circumferential sections having an overlap in the circumferential direction with the second ball tracks 23B. Viewed in longitudinal section through the track base, as shown in the lower half of the section of FIG. 1D, the recessed portions 32 are recessed relative to a continued imaginary track base line L29B and extend axially to the first end face 27. The recessed portions 32 can be designed such that a radial thickness RB20 of the recessed portions at the front end face 27 is smaller than 1.3 times, in particular smaller than 1.2 times or 1.1 times, the radial thickness RB19 in the circumferential sections of the second ball tracks 23B at the rear end face 28. It is also possible that the radial thickness RB20 of the annular portion at the front side is smaller than the radial thickness RB19 at the rear side.

The first ball tracks 23A have a central section 23Ac for guiding the associated ball 14A during operation, and a front section 23Af extending to the front end face 27 and a rear section 23Ar extending to the rear end face 28 which has no guiding function during operation of the joint. The inner joint member 13 has a smallest radial thickness RA20 in the region of the front track sections 23Af at the front end face 27. The recessed portions 32 on the second ball tracks 23B can be designed such that the ring area 34 of the inner joint member 13 surrounding the through-opening has similar radial thicknesses in circumferential overlap with the first ball tracks 23A and the second ball tracks 23B. In particular, at the front end face 27, the smallest radial thickness RB20 of the inner joint member 13 in the recessed portions 32 on the second ball tracks 23B can be less than 1.3 times, in particular less than 1.2 times or 1.1 times, the smallest radial thickness RA20 of the inner joint member 13 in the circumferential sections of the first ball tracks 23A. However, the radial thickness RB20 below the recessed portions 32 can also be equal to or smaller than the radial thickness RA20 below the front sections of the first ball tracks 23A.

In the present embodiment, it is further provided that the recess portions 32 extend over at least ±10° with respect to a radial plane E23B, which is spanned by a base line of the associated ball track 23B. In the present case, the circumferential extension of the recess portions 32 is in each case smaller than an angular pitch between two web sections 25, respectively two ball tracks adjacent to each other in the circumferential direction. As can be seen in particular in FIGS. 1A and 1B, the web sections adjacent to the recesses 32 in the circumferential direction merge continuously into the front end face 27. A partial number of the web sections 25 can have a flattened area 35 on one or both axial sides to simplify assembly. Thus, the axial length of the web section 25 provided with flattenings 35 is smaller than the circumferential extension of a cage window 18 of the ball cage 15 and can be introduced therein during assembly.

In the present embodiment, the circumferentially distributed recessed portions 32, which can also be referred to as recesses, extend over a relatively large axial length L32 starting from the front end face 27. The axial length 32 of the recesses is more than 0.5 times the axial length L13 of the inner joint member 13. In the present embodiment, the recesses have a straight contour when viewed in longitudinal section, although a curved shape is also possible.

One or more of the above-mentioned features can improve the stress distribution over the circumference of the inner joint member 13, which leads to a longer service life.

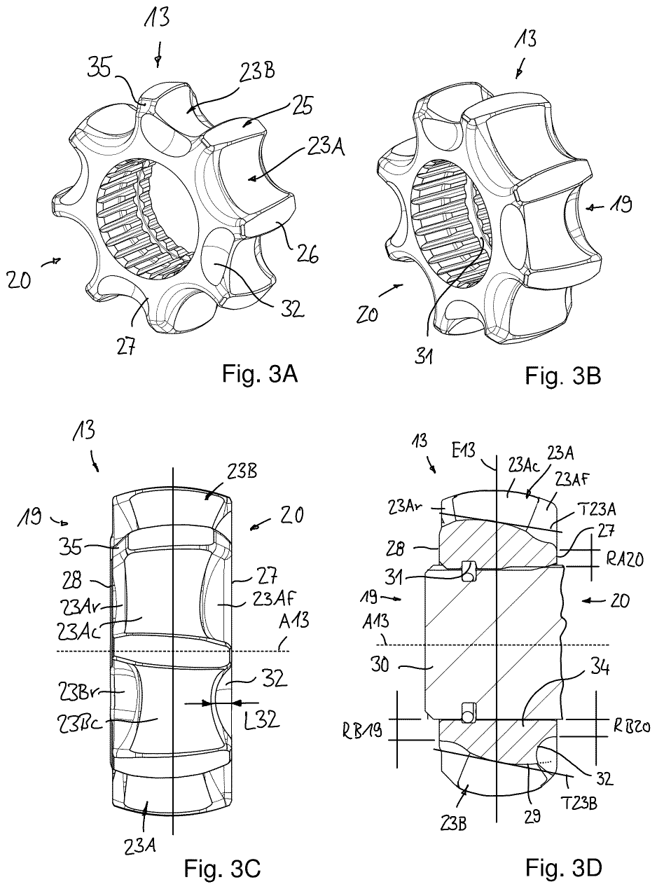

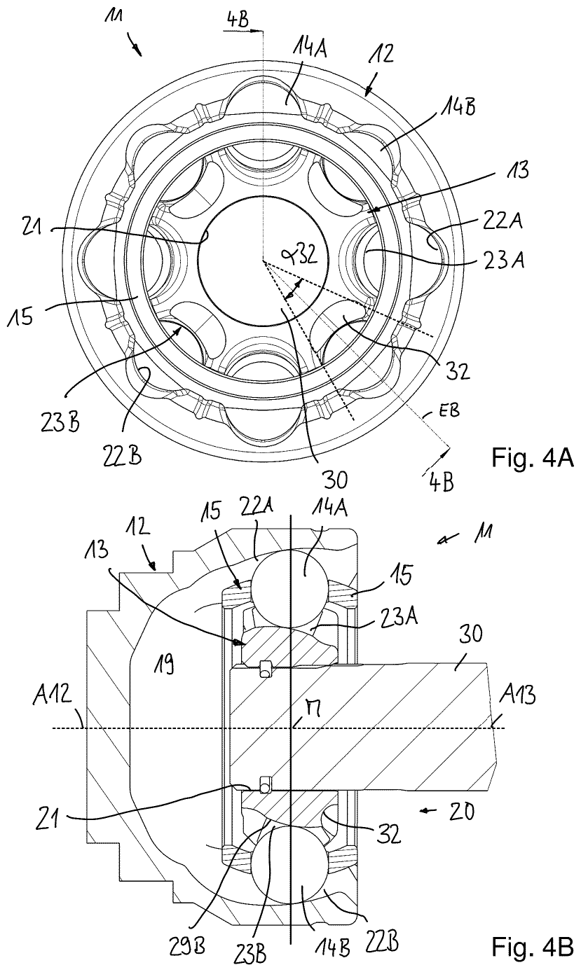

FIGS. 3A to 3D show a further embodiment of an inner joint member 13 for a counter track joint 11. This largely corresponds to the embodiment shown in FIGS. 1A to 1D, to the description of which reference is made in brief. The same and/or corresponding details are provided with the same reference signs as in the inner joint member shown in FIG. 1. An corresponding counter track joint 11 is shown in FIGS. 4A and 4B, wherein reference is also made briefly to the description of FIG. 2 with regard to common features.

A specific feature of the present embodiment according to FIG. 3 is that the recessed portions 32 have a smaller axial extension and a larger circumferential extension than in the embodiment according to FIG. 1. Specifically, the recessed portions 32 can extend over at least ±15° with respect to the radial plane E23B spanned by the track base line. The axial length L32 is greater than 0.1 times and in particular less than 0.3 times the axial length L13 of the inner joint member 13. The recessed portions 32 are also concavely rounded when viewed in longitudinal section.

Also in the present embodiment according to FIG. 3, the smallest radial thickness RB20 of the inner joint member 13 in the recess portions 32 at the second ball tracks 23B is less than 1.3 times, in particular less than 1.1 times, the smallest radial thickness RB19 of the second ball tracks 23B at the rear end face and/or less than 1.3 times, in particular less than 1.1 times, the smallest radial thickness RA20 of the first ball tracks 23A at the front end face.

In the present embodiment, one or more of the features mentioned can be used to improve the stress distribution over the circumference of the inner joint member 13, which leads to a longer service life.

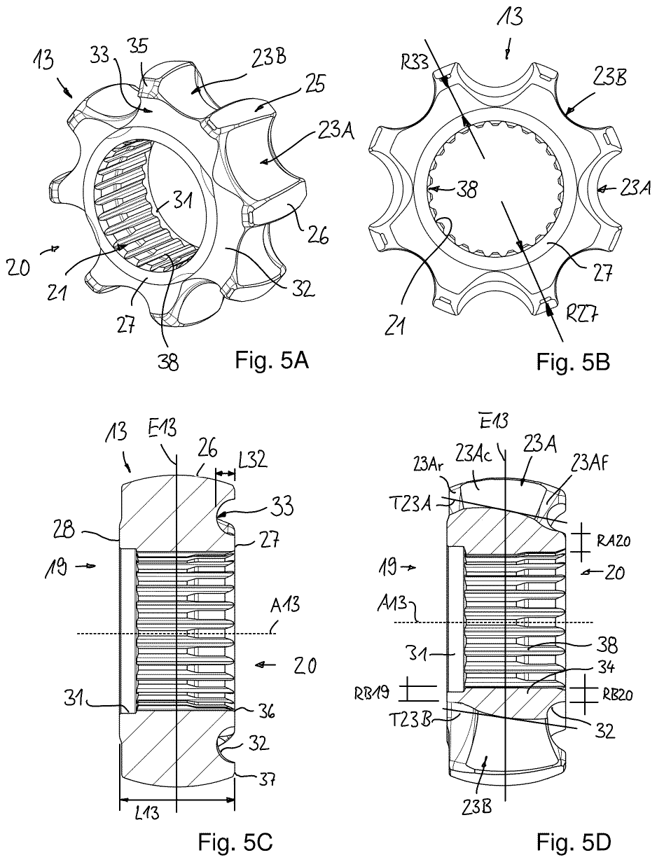

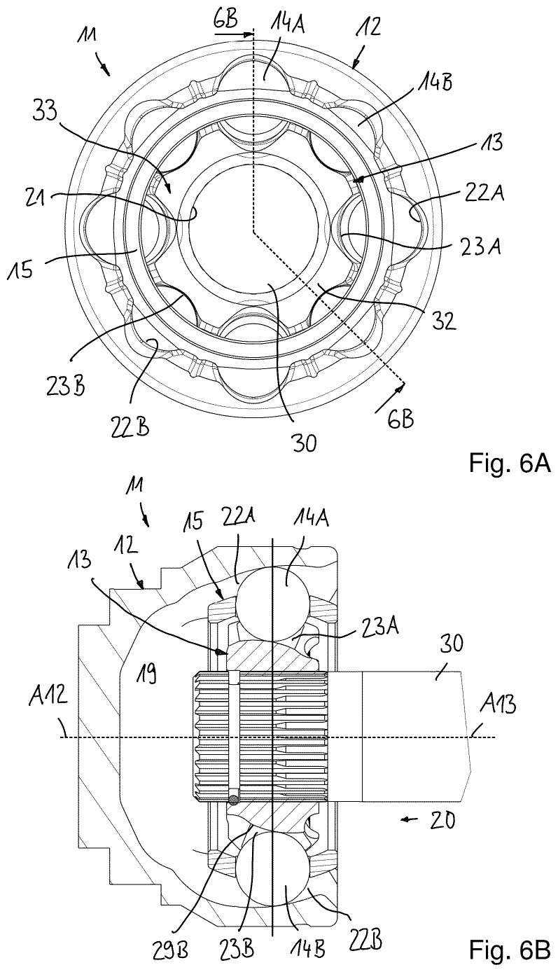

FIGS. 5A to 5D show an inner joint member 13 in a further embodiment for a counter track joint 11. This largely corresponds to the embodiments shown in FIGS. 1A to 1D and respectively FIGS. 3A to 3D, to which reference is made briefly in this respect. The same and/or corresponding details are provided with the same reference signs as for the inner joint members shown in FIGS. 1 and 3. A counter track joint 11 with an inner joint member as shown in FIG. 5 is shown in FIGS. 6A and 6B. With regard to the joint-related features, abbreviated reference is made to the description of FIG. 2, wherein identical and/or corresponding details are provided with the same reference signs.

A characteristic feature of the embodiment shown in FIG. 5 is that the recessed portions 32 are formed by an annular groove 33 arranged in the front end face 27 coaxially to the longitudinal axis A13. As can be seen in particular in FIGS. 5C and 5D, the annular groove 33 is arranged radially between an inner edge 36 and an outer edge 37 of the front end face 27. Viewed in semi-longitudinal section, the annular groove 33 has a radial extension Sr33 of at least 0.3 times the radial extent Sr27 from the inner edge to the outer edge of the front end face 27. In cross-section through the annular groove 33, the latter has a particularly rounded shape, for example a C-shaped contour. The axial depth La33 of the annular groove 33 is in particular at least 0.1 times the axial length L13 of the inner joint member 13. In the present embodiment, only one single recess is provided, which is annular and intersects the front sections of all first and second ball tracks 23A, 23B in the circumferential direction. The annular groove 33 can be easily formed in the end face of the inner joint member 13 by a turning or forming process.

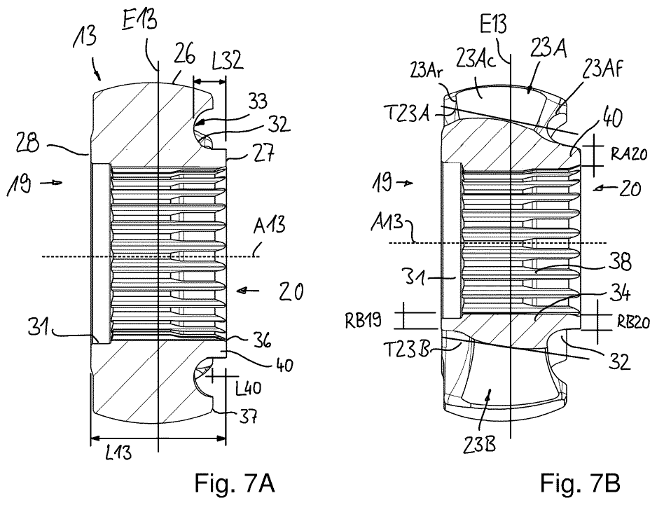

FIGS. 7A and 7B show an inner joint member 13 in a further embodiment for a counter track joint 2. This corresponds largely to the embodiment shown in FIGS. 5A to 5D, to the description of which reference is made in brief. Identical and/or corresponding details are assigned the same reference signs as in the inner joint member shown in FIG. 5. A characteristic feature of the embodiment according to FIG. 7 is that the inner joint member 13 has an axially protruding ring area 34 and thus a longer engagement structure 38. For this purpose, the inner joint member 13 has a sleeve projection 40 that protrudes axially from the front end of the web sections 25. The sleeve projection 40 has an axial length L40, which can be, for example, between 0.5 and 3 times the radial thickness RB20 below the recesses 32. An embodiment with an axial sleeve projection 40 on the front side 20 can contribute to a particularly homogeneous stress distribution.

The inner joint members 13 as described above all have the advantage that the ring portion surrounding the through opening 21, in particular in the front axial end section, has a largely uniform stiffness in the circumferential sections of the first and second ball tracks 23A, 23B. This in turn leads to a more uniform stiffness of the inner joint member 13 in the circumferential sections of the first and second ball tracks 23A, 23B and thus in turn to a more uniform load on the engagement structure 38 of the inner joint member 13. In the embodiment according to FIG. 5 with a ring-shaped recess, the stress level of the engagement structure 38 in the circumferential sections of the first ball tracks 23A may increase under certain circumstances. However, the stresses in these circumferential sections are then still lower than in the circumferential sections of the second ball tracks 23B. Overall, an improved stress distribution in the inner joint member 13 and thus a longer service life is achieved.

Certain embodiments or components or features of components have been noted herein as being “preferred” and some options as being “preferable” or the like and such indications are to be understood as relating to a preference of the applicant at the time this application was filed. Such embodiments, components or features noted as being “preferred” or “preferable” or the like are optional and are not required for implementation of the innovations disclosed herein unless otherwise indicated as being required, or specifically included within the claims that follow.

1. An inner joint member for a counter track joint, comprising:
a through-opening with a longitudinal axis and an engagement structure into which a drive shaft is axially insertable from a front side for transmitting torque, wherein the through-opening has an axial securing structure between a center plane and a rear side for axially securing of the drive shaft,
first ball tracks which, viewed in the center plane, are inclined towards the front side, wherein the inner joint member has a smallest radial thickness at the front side radially between the first ball tracks and the through-opening,
second ball tracks which, viewed in the center plane, are inclined towards the rear side,
wherein the inner joint member has, at least in circumferential sections involving the second ball tracks, recesses which, viewed in longitudinal section through the track base, are recessed relative to a continued imaginary track base line and extend axially to the front side, wherein a radial thickness formed at the front side between the recess and the through-opening is smaller than 1.3 times the smallest radial thickness between the first ball tracks and the through-opening at the front side.

2. The inner joint member according to claim 1,
wherein the first ball tracks each have a central section for guiding an associated ball during operation, a front section extending toward a front end face and a rear section extending toward a rear end face,
wherein the recesses are designed such that a smallest radial thickness between a respective one of the recesses and the through-opening is less than 1.1 times the smallest radial thickness between the front portion of the first ball tracks and the through-opening.

3. The inner joint member according to claim 1,
wherein, with respect to the second ball tracks, the radial thickness formed on the front side between a respective one of the recesses and the through-opening is smaller than 1.3 times a smallest radial thickness formed on the rear side between the second ball tracks and the through-opening.

4. The inner joint member according to claim 1,
wherein the recesses, viewed in an axial view, each extend over a circumferential angle of at least ±10° with respect to a radial plane defined by a track base line of the associated second ball track.

5. The inner joint member according to claim 4,
wherein the recesses each have a circumferential extension which is smaller than an angular pitch between two web sections adjacent to each other in circumferential direction,
wherein web sections adjacent to the recesses in circumferential direction merge continuously into the front end face of the inner joint member.

6. The inner joint member according to claim 5,
wherein the recesses each extend from the front end face over an axial length of at least 0.1 times an axial length of the inner joint member.

7. The inner joint member according to claim 5,
wherein the recesses have a rounded concave shape when viewed in longitudinal section.

8. The inner joint member according to claim 1,
wherein the recesses are formed by an annular groove provided in the front end face coaxially to the longitudinal axis, with the annular groove being arranged radially between an inner edge and an outer edge of the front end face.

9. The inner joint member according to claim 8,
wherein the annular groove has a rounded contour when viewed in longitudinal section.

10. The inner joint member according to claim 8,
wherein the annular groove, starting from the front end face, has an axial depth of at least 0.1 times the axial length of the inner joint member.

11. The inner joint member according to claim 8,
wherein the annular groove intersects in circumferential direction with front sections of the first ball tracks.

12. The inner joint member according to claim 11,
wherein the front sections of the first ball tracks, in respective intersection regions with the annular groove, are recessed relative to an annular face formed by the annular groove.

13. The inner joint member according to claim 8,
wherein the annular groove, viewed in semi-longitudinal section, has a radial extension of at least 0.3 times the radial extent from the inner edge to the outer edge of the front end face.

14. A constant velocity joint in the form of a counter track joint, comprising:
an outer joint member comprising a longitudinal axis, a connection side and an opening side as well as first ball tracks and second ball tracks; and
an inner joint member comprising a through-opening with a longitudinal axis and an engagement structure into which a drive shaft is axially insertable from a front side for transmitting torque, wherein the through-opening has an axial securing structure between a center plane and a rear side for axially securing of the drive shaft, first ball tracks which, viewed in the center plane, are inclined towards the front side, wherein the inner joint member has a smallest radial thickness at the front side radially between the first ball tracks and the through-opening, second ball tracks which, viewed in the center plane, are inclined towards the rear side, wherein the inner joint member has, at least in circumferential sections involving the second ball tracks, recesses which, viewed in longitudinal section through the track base, are recessed relative to a continued imaginary track base line and extend axially to the front side, wherein a radial thickness formed at the front side between the recess and the through-opening is smaller than 1.3 times the smallest radial thickness between the first ball tracks and the through-opening at the front side;
wherein the first ball tracks of the outer joint member and the first ball tracks of the inner joint member together form first pairs of ball tracks which widen towards the front side of the outer joint member in the aligned state of the counter track joint, and
wherein the second ball tracks of the outer joint member and the second ball tracks of the inner joint member together form second pairs of ball tracks which, in an aligned state of the counter track joint, widen towards the rear side (19) of the outer joint member;
a torque-transmitting ball in each first pair of ball tracks and in each second pair of ball tracks; and
an annular ball cage arranged between the outer joint member and the inner joint member and having cage windows distributed in the circumferential direction, in each of which at least one of the torque-transmitting balls is received.

15. The constant velocity joint according to claim 14,
wherein the counter track joint is designed for operating articulation angles of less than 25°.
